(19) United States
(12) Patent Application Publication
(10) Pub. No.: US 2026/0005553 A1
(43) Pub. Date: Jan. 1, 2026

(54) ADJUSTABLE DELAY TO CONTROL NODE MISMATCH

(71) Applicant: Renesas Electronics America Inc., Milpitas, CA (US)

(72) Inventors: Gustavo James MEHAS, Fall City, WA (US); Sercan IPEK, Zurich (CH); Marco SAUTTO, Zurich (CH)

(73) Assignee: Renesas Electronics America Inc., Milpitas, CA (US)

(21) Appl. No.: 19/203,377

(22) Filed: May 9, 2025

Related U.S. Application Data
(60) Provisional application No. 63/665,247, filed on Jun. 27, 2024.

(51) Int. Cl. H02J 50/80; H02J 50/10

(52) U.S. Cl. CPC H02J 50/80; H02J 50/10

(57) ABSTRACT

A wireless power transmitter is disclosed that comprises a coil, a first node electrically connected to a first side of the coil, a second node electrically connected to a second side of the coil, a plurality of transistors that are configured to drive the coil via the first and second nodes between a first voltage potential and a second voltage potential and a monitor circuit that is configured to determine the timing at which a first voltage of the first node and a second voltage of the second node cross a halfway point between the first voltage potential and the second voltage potential. The wireless power transmitter further comprises a feedback circuit that is configured to adjust a delay corresponding to at least one transistor of the plurality of transistors based at least in part on the first and second times.

### CROSS-REFERENCE TO RELATED APPLICATION

The subject application claims the benefit of U.S. Provisional Application No. 63/665,247, filed on Jun. 27, 2024. The entire disclosure of U.S. Provisional Application No. 63/665,247 is incorporated by this reference.

### BACKGROUND OF THE SPECIFICATION

The present disclosure relates in general to apparatuses and methods for communication between wireless power transmitters and wireless power receivers.

Wireless power systems often include a transmitter and a receiver having a receiver coil. When a transmission coil of the transmitter and the receiver coil of the receiver are positioned close to one another they form a transformer that facilitates inductive transmission of an alternating current (A C) power between the transmitter and the receiver. The receiver often includes a rectifier circuit that converts the AC power into a direct current (DC) power that may be utilized for various loads or components that require DC power to operate. The transmitter and the receiver also utilize the transformer to exchange information or messages using various modulation schemes. For example, the receiver may include a resonant circuit having one or more capacitors and may switch in or switch out a different number of capacitors of the resonant circuit to generate amplitude shift key (ASK) signals and encode messages in the ASK signals. The receiver can transmit the ASK signals to the transmitter to communicate with the transmitter via the transformer. The transmitter decodes the messages from the ASK signals received from the receiver and encodes response messages in frequency shift key (FSK) signals that may be transmitted back to the receiver via the transformer.

### SUMMARY

In an embodiment, a wireless power transmitter is disclosed that comprises a coil, a first node electrically connected to a first side of the coil, a second node electrically connected to a second side of the coil and a first transistor in electrical communication with a first voltage potential and the first node. The first transistor is configured to electrically connect the first voltage potential to the first node based on a first command signal. The wireless power transmitter further comprises a second transistor in electrical communication with a second voltage potential and the second node. The second transistor is configured to electrically connect the second voltage potential to the second node based on a second command signal. The first transistor and the second transistor are configured to transition the first node from the first voltage potential toward the second voltage potential and the second node from the second voltage potential toward the first voltage potential based on the first and second command signals. The wireless power transmitter further comprises a monitor circuit that is configured to determine a first time at which a first voltage of the first node crosses a halfway point between the first voltage potential and the second voltage potential and determine a second time at which a second voltage of the second node crosses the halfway point between the second voltage potential and the first voltage potential. The wireless power transmitter further comprises a feedback circuit that is configured to adjust a delay of the second command signal based at least in part on one of the first and second times occurring before the other of the first and second times.

In another embodiment, a wireless power transmitter is disclosed that comprises a coil, a first node electrically connected to a first side of the coil, a second node electrically connected to a second side of the coil and a first transistor in electrical communication with a first voltage potential and the first node. The first transistor is configured to electrically connect the first voltage potential to the first node based on a first command signal. The wireless power transmitter further comprises a second transistor in electrical communication with a second voltage potential and the second node. The second transistor is configured to electrically connect the second voltage potential to the second node based on a second command signal. The first transistor and the second transistor are configured to transition the first node from the first voltage potential toward the second voltage potential and the second node from the second voltage potential toward the first voltage potential based on the first and second command signals during a first half of a switching cycle. The wireless power transmitter further comprises a third transistor in electrical communication with the first voltage potential and the second node. The third transistor is configured to electrically connect the first voltage potential to the second node based on a third command signal. The wireless power transmitter further comprises a fourth transistor in electrical communication with the second voltage potential and the first node. The fourth transistor is configured to electrically connect the second voltage potential to the first node based on a fourth command signal. The third transistor and the fourth transistor are configured to transition the first node from the second voltage potential toward the first voltage potential and the second node from the first voltage potential toward the second voltage potential based on the third and fourth command signals during a second half of the switching cycle. The wireless power transmitter further comprises a monitor circuit that is configured to determine a first time at which a first voltage of the first node crosses a halfway point between the first voltage potential and the second voltage potential and determine a second time at which a second voltage of the second node crosses the halfway point between the second voltage potential and the first voltage potential. The wireless power transmitter further comprises a feedback circuit that is configured to adjust a delay of the second command signal based at least in part on one of the first and second times occurring before the other of the first and second times during the first half of the switching cycle and adjust a delay of the fourth command signal based at least in part on one of the first and second times occurring before the other of the first and second times during the second half of the switching cycle.

In another embodiment, a wireless power transmitter is disclosed that comprises a coil, a first node electrically connected to a first side of the coil, a second node electrically connected to a second side of the coil, a plurality of transistors that are configured to drive the coil via the first and second nodes between a first voltage potential and a second voltage potential and a monitor circuit that is configured to determine a first time at which a first voltage of the first node crosses a halfway point between the first voltage potential and the second voltage potential and determine a second time at which a second voltage of the second node crosses the halfway point between the second voltage potential and the first voltage potential. The wireless power transmitter further comprises a feedback circuit that is configured to adjust a delay corresponding to at least one transistor of the plurality of transistors based at least in part on one of the first and second times occurring before the other of the first and second times.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a block diagram of an example system for wireless power transfer according to an embodiment.

FIG. 2 is a signal diagram illustrating an example power driver of a transmitter of the system of FIG. 1 according to an embodiment.

FIG. 3 is a signal diagram illustrating an example level shifter delay to the ½ bridge crossings of the SW1 and SW2 nodes of the power driver of FIG. 2 according to an embodiment.

FIG. 4 is a signal diagram illustrating an example capacitor delay to the ½ bridge crossings of the SW1 and SW2 nodes of the power driver of FIG. 2 according to an embodiment.

FIG. 5 is a signal diagram illustrating an example result of a delay adjustment by the power driver of FIG. 2 to the ½ bridge crossings of the SW1 and SW2 nodes according to an embodiment.

FIG. 6 is a signal diagram illustrating example monitoring and feedback to adjust a delay for the SW2 node of the power driver of FIG. 2 according to an embodiment.

FIG. 7 is a signal diagram illustrating example monitoring and feedback to adjust a delay for the SW1 node of the power driver of FIG. 2 according to an embodiment.

FIG. 8 is a signal diagram illustrating an implementation of adjustable delays over multiple cycles to correct for mismatched ½ bridge crossings of the SW1 and SW2 nodes of the power driver of FIG. 2 according to an embodiment.

FIG. 9 is an eye diagram illustrating an implementation of adjustable delays over multiple cycles to correct for mismatched ½ bridge crossings of the SW1 and SW2 nodes of the power driver of FIG. 2 according to an embodiment.

FIG. 10 is an eye diagram illustrating an implementation of dithered adjustable delays over multiple cycles to maintain de-skewed ½ bridge crossings of the SW1 and SW2 nodes of the power driver of FIG. 2 according to an embodiment.

### DETAILED DESCRIPTION

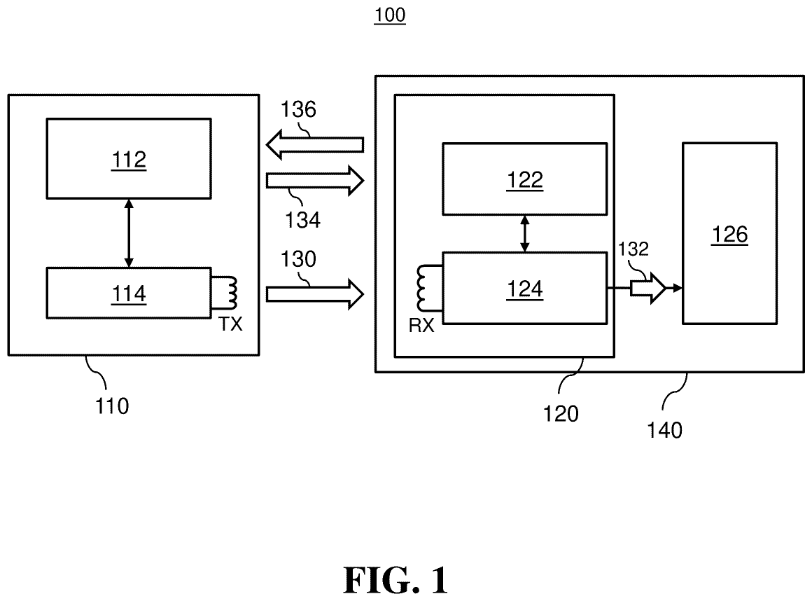

FIG. 1 is a diagram showing an example system 100 that implements wireless power transfer and communication according to an illustrative embodiment. System 100 comprises a transmitter 110 and a receiver 120 that are configured to wirelessly transfer power and data therebetween via inductive coupling. While described herein as transmitter 110 and receiver 120, each of transmitter 110 and receiver 120 may be configured to both transmit and receive power or data therebetween via inductive coupling.

Transmitter 110 is configured to transmit A C power to receiver 120 wirelessly. Transmitter 110 comprises a controller 112 and a power driver 114.

Controller 112 is configured to control and operate power driver 114. Controller 112 comprises, for example, a processor, central processing unit (CPU), field-programmable gate array (FPGA) or any other circuitry that is configured to control and operate power driver 114. While described as a CPU in illustrative embodiments, controller 112 is not limited to a CPU in these embodiments and may comprise any other circuitry that is configured to control and operate power driver 114. In an example embodiment, controller 112 is configured to control power driver 114 to drive a coil TX of the power driver 114 to produce a magnetic field. Power driver 114 is configured to drive coil TX at a range of frequencies and configurations defined by wireless power standards, such as, e.g., the Wireless Power Consortium (Qi) standard, the Power Matters Alliance (PMA) standard, the Alliance for Wireless Power (A for WP, or Rezence) standard or any other wireless power standards.

Receiver 120 is configured to receive AC power transmitted from transmitter 110 and to supply the power to one or more loads 126 or other components of a destination device 140. Destination device 140 may comprise, for example, a computing device, mobile device, mobile telephone, smart device, tablet, wearable device or any other electronic device that is configured to receive power wirelessly. In an illustrative embodiment, destination device 140 comprises receiver 120. In other embodiments, receiver 120 may be separate from destination device 140 and connected to destination device 140 via a wire or other component that is configured to provide power to destination device 140.

Receiver 120 comprises a controller 122 and a power rectifier 124. Controller 122 comprises, for example, a processor, central processing unit (CPU), field-programmable gate array (FPGA) or any other circuitry that may be configured to control and operate power rectifier 124. Power rectifier 124 includes a coil RX and is configured to rectify power received via coil RX into a power type as needed for load 126. Power rectifier 124 is configured to rectify AC power received from coil RX into DC power which may then be supplied to load 126.

As an example, when receiver 120 is placed in proximity to transmitter 110, the magnetic field produced by coil TX of power driver 114 induces a current in coil RX of power rectifier 124. The induced current causes AC power 130 to be inductively transmitted from power driver 114 to power rectifier 124. Power rectifier 124 receives AC power 130 and converts AC power 130 into DC power 132. DC power 132 is then provided by power rectifier 124 to load 126. Load 126 may comprise, for example, a battery charger that is configured to charge a battery of the destination device 140, a DC-DC converter that is configured to supply power to a processor, a display, or other electronic components of the destination device 140, or any other load of the destination device 140.

Transmitter 110 and receiver 120 are also configured to exchange information or data, e.g., messages, via the inductive coupling of power driver 114 and power rectifier 124. For example, before transmitter 110 begins transferring power to receiver 120, a power contract may be agreed upon and created between receiver 120 and transmitter 110. For example, receiver 120 may send communication packets or other data to transmitter 110 that indicate power transfer information such as, e.g., an amount of power to be transferred to receiver 120, commands to increase, decrease, or maintain a power level of AC power 130, commands to stop a power transfer, or other power transfer information. In another example, in response to receiver 120 being brought in proximity to transmitter 110, e.g., close enough such that a transformer may be formed by coil TX and coil RX to facilitate power transfer, receiver 120 may be configured to initiate communication by sending a signal to transmitter 110 that requests a power transfer. In such a case, transmitter 110 may respond to the request by receiver 120 by establishing the power contract or beginning power transfer to receiver 120, e.g., if the power contract is already in place.

Transmitter 110 and receiver 120 may transmit and receive communication packets, data or other information via the inductive coupling of coil TX and coil RX. As an example, communication packet sent from transmitter 110 to receiver 120 may comprise frequency shift key (FSK) signals 134. FSK signals 134 are frequency modulated signals that represent digital data using variations in the frequency of a carrier wave. Communication packets sent from receiver 120 to transmitter 110 may comprise amplitude shift key (ASK) signals 136. ASK signals 136 are amplitude modulated signals that represent digital data using variations in the amplitude of a carrier wave. While transmitter 110 is described as sending FSK signals 134 and receiver 120 is described as sending ASK signals 136, in other embodiments, receiver 120 may alternatively send FSK signals and transmitter 110 may alternatively send ASK signals. Any other manner of transmitting communication packets, data or other information between transmitter 110 and receiver 120 may alternatively be used.

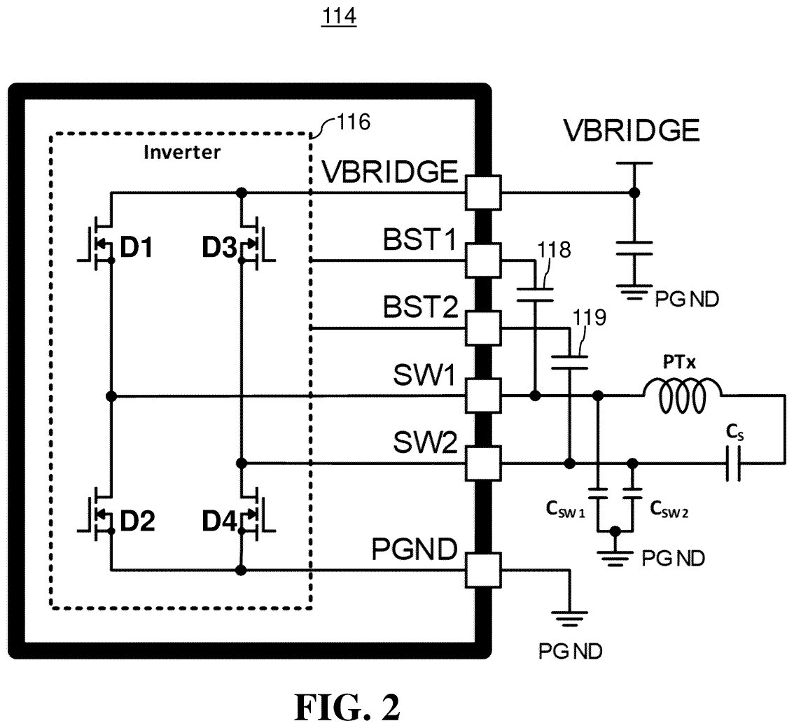

Referring to FIGS. 1 and 2, power driver 114 of transmitter 110 according to an illustrative embodiment will be described in more detail. Power driver 114 comprises an inverter 116 comprising power switches D1, D2, D3 and D4 that control power delivery from power source VBRIDGE through a coil PTx of power driver 114, also referenced as TX in FIG. 1.

Inverter 116 is connected to power supply VBRIDGE, ground PGND and comprises outputs SW1, SW2, BST1 and BST2. SW1 and SW2 may also be collectively and individually referred to herein as SW nodes. SW1 is connected to a first side of coil PTx. SW2 is connected to a second side of coil PTx via a capacitor Cs. BST1 is connected to SW1 via a capacitor 118 such that capacitor 118 is charged and discharged based on SW1. BST2 is connected to SW2 via a capacitor 119 such that capacitor 119 is charged and discharged based on SW2. In some embodiments, PGND may comprise a true ground. In other embodiments, PGND may have a predetermined reference voltage level. VBRIDGE and PGND may also be referred to herein as a first voltage potential and a second voltage potential.

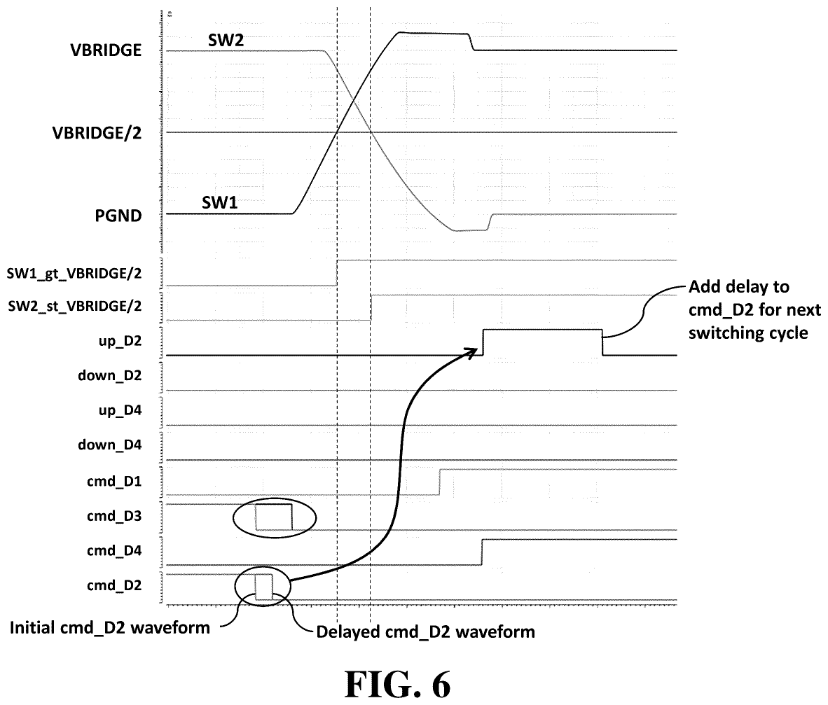

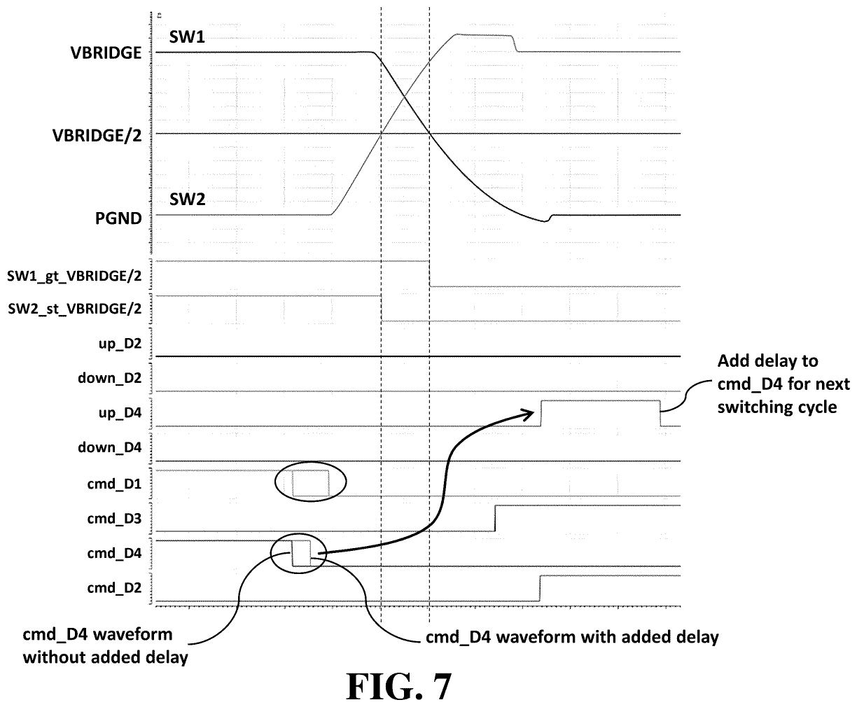

One SW node will initially be set to PGND while the other will be set to VBRIDGE. During a switching cycle, the SW node set to PGND, e.g., SW1 in the example presented in FIG. 6, will transition to VBRIDGE while the SW node set to VBRIDGE, e.g., SW2 in the example presented in FIG. 6, will transition to PGND, followed by the reverse as shown in the example of FIG. 7. The switching of a SW node from one of VBRIDGE and PGND to the other and back may also be referred to herein as a switching cycle or full switching cycle.

Controller 112 of transmitter 110 communicates with power driver 114 using signals cmd_D1, cmd_D2, cmd_D3 and cmd_D4 (FIGS. 7-10) such as, e.g., pulse-width modulation (PWM) signals or other signals, to control and operate corresponding power switches D1-D4 of inverter 116. Power switches D1-D4 are utilized to provide power or data to receiver 120 via coil PTx. As an example, controller 112 may be configured to supply signals cmd_D1, cmd_D2, cmd_D3 and cmd_D4 to inverter 116 for controlling and operating power switches D1, D2, D3 and D4 of inverter 116. In an illustrative embodiment, the PWM signals are not encoded by controller 112 and decoded by inverter 116 but instead are provided as-is to inverter 116. In other embodiments, the PWM signals may alternatively be encoded by controller 112 and decoded by power driver 114 more generally or by inverter 116.

Signal cmd_D1 controls the gate of power switch D1, e.g., a metal-oxide semiconductor field-effect transistor (MOSFET), to control the activation of power switch D1. When power switch D1 is activated by cmd_D1, the source/drain of the MOSFET connects VBRIDGE to SW1.

Signal cmd_D2 controls the gate of power switch D2, e.g., a metal-oxide semiconductor field-effect transistor (MOSFET), to control the activation of power switch D2. When power switch D2 is activated by cmd_D2, the source/drain of the MOSFET connects PGND to SW1.

Signal cmd_D3 controls the gate of power switch D3, e.g., a metal-oxide semiconductor field-effect transistor (MOSFET), to control the activation of power switch D3. When power switch D3 is activated by cmd_D3, the source/drain of the MOSFET connects VBRIDGE to SW2.

Signal cmd_D4 is controls the gate of power switch D4, e.g., a metal-oxide semiconductor field-effect transistor (MOSFET), to control the activation of power switch D4. When power switch D4 is activated by cmd_D4, the source/drain of the MOSFET connects PGND to SW2.

While power switches D1-D4 are described herein as MOSFETs, in other embodiments, any other type of transistor or switching component may alternatively be utilized.

Power driver 114 also comprises a capacitor disposed between VBRIDGE and PGND in parallel with power switches D1 and D3.

Power switches D1-D4 are configured to control nodes SW1 and SW2 to drive coil PTx to generate a magnetic field according one or more of the signals cmd_D1, cmd_D2, cmd_D3 and cmd_D4, e.g., PWM signals, received by power driver 114 for providing power or data inductively to another device such as, e.g., receiver 120 (FIG. 1). While an example configuration of MOSFETs and capacitors is shown in FIG. 2, any other configuration of MOSFETs and capacitors may alternatively be utilized to drive coil PTx.

In an embodiment, power transmitter 110 utilizes zero voltage switching instead of hard switching to reduce electro-magnetic interference (EMI) in power driver 114. Power driver 114 may also comprise a capacitor C_{SW1} disposed between SW1 and PGND and a capacitor C_{SW2} disposed between SW2 and PGND in some embodiments. The slew rate of nodes SW1 and SW2 may be further reduced by the use of capacitors C_{SW1} and C_{SW2} which may also provide additional EMI mitigation.

In some embodiments, performance may be further improved by balancing the zero voltage transition such that signals on both SW nodes have no mismatch in time, or as small as possible a mismatch, as they cross through the halfway point between VBRIDGE and PGND, also referred to herein as the ½ VBRIDGE voltage level or VBRIDGE/2.

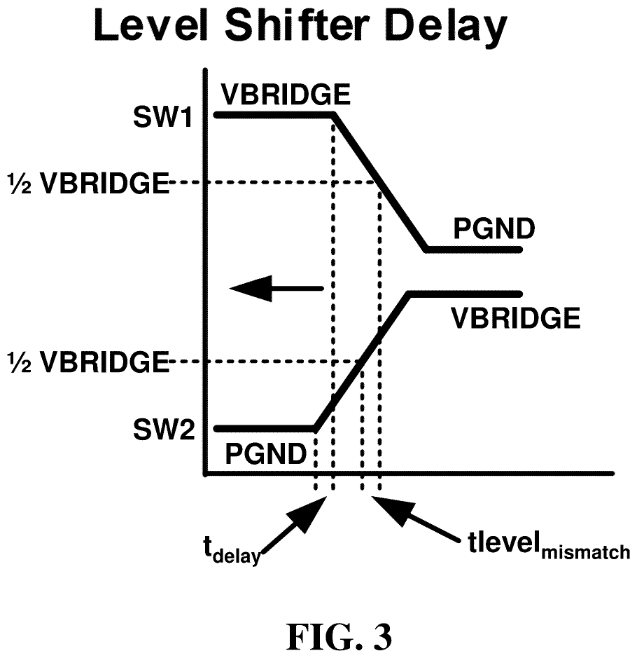

With reference to FIG. 3, for example, level shifter delays may cause a mismatch between the SW nodes which may be challenging to overcome. For example, if the control signals that control the SW nodes, e.g., cmd_D1, cmd_D2, cmd_D3 and cmd_D4, change their values at the same time or in conjunction with each other at a particular desired timing pattern, level shifter delays may cause the timing at which the SW node that was at VBRIDGE begins transitioning toward PGND to be delayed by an amount t_{delay} relative to the timing at which the SW node that was at PGND begins transitioning toward VBRIDGE. In the example of FIG. 3, SW1 begins at VBRIDGE while SW2 begins at PGND although these values may be reversed during the other half of the switching cycle. This delay t_{delay} causes a level shifter mismatch tlevel_{mismatch} between when SW2 crosses ½ VBRIDGE and SW1 crosses ½ VBRIDGE, also resulting in SW2 achieving VBRIDGE before SW1 achieves PGND. Mismatches between the ½ VBRIDGE crossings of the SW nodes may cause an increase in EMI in some embodiments.

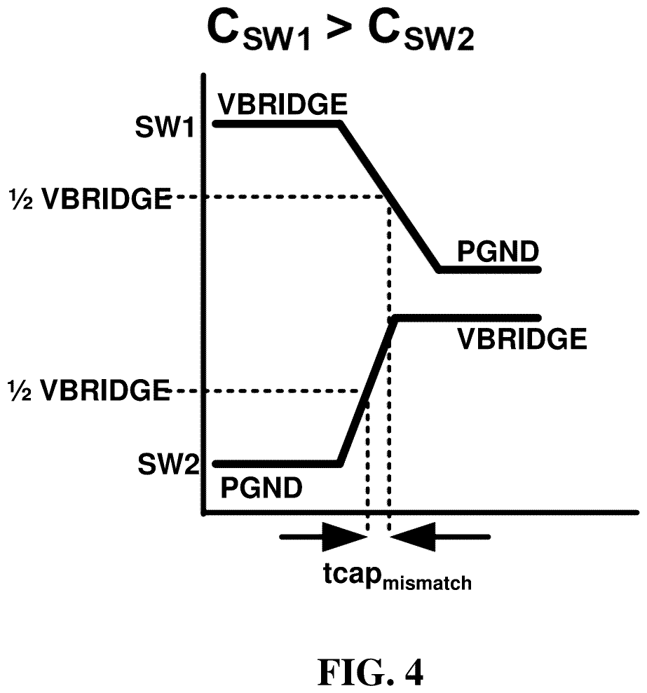

With reference to FIG. 4, in some cases, variations in the charge values of C_{SW1} and C_{SW2} may also cause a mismatch in the ½ VBRIDGE crossing time. As an example, if C_{SW1} is greater than C_{SW2} when SW1 is transitioning from VBRIDGE to PGND, the transition of SW1 may be delayed relative to the transition of SW2 from PGND to VBRIDGE by a capacitor mismatch tcap_{mismatch}. Similarly, if C_{SW2} is greater than C_{SW1} when SW2 is transitioning from VBRIDGE to PGND, the transition of SW2 may be delayed relative to the transition of SW1 from PGND to VBRIDGE by a capacitor mismatch. In some embodiments, tlevel_{mismatch} and tcap_{mismatch} may be added together to determine a total mismatch t_{mismatch} between the ½ VBRIDGE crossings of SW1 and SW2 or may be combined in any other manner.

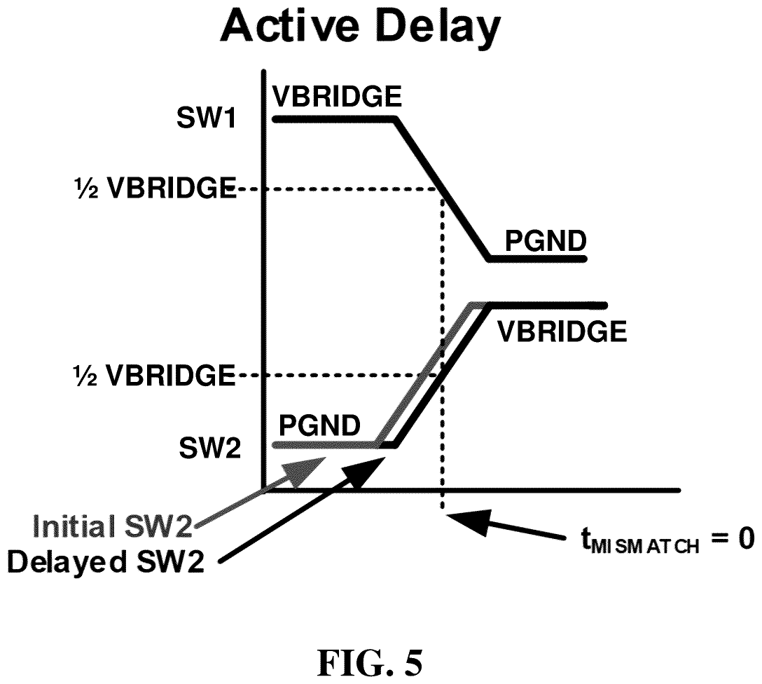

In an embodiment, these mismatch challenges may be overcome by implementing a variable delay on one or both of the SW nodes. For example, t_{mismatch} may be monitored by tracking the time at which each SW node crosses ½ VBRIDGE whether one of the SW nodes is earlier than the other. In a case where one of the SW nodes is earlier than the other, a delay may be implemented on one or more of the cmd signals, an existing delay may be adjusted or other actions may be taken on the next switching cycle in an attempt to align the ½ VBRIDGE crossings and mitigate the mismatch. For example, as shown in FIG. 5, if it is determined that SW2 is earlier than SW1, e.g., SW1 is delayed relative to SW2 by t_{mismatch} due to level shifter delays, C_{SW1} and C_{SW2} related delays, both or another delay such as, e.g., temperature related variations, the cmd signal for transitioning SW2 may be delayed relative to the cmd signal for transitioning SW1 in order to achieve a closer match to SW1 the next time SW2 transitions from PGND to VBRIDGE and to drive t_{mismatch} toward 0. Some example internal and external system parameters that may cause a delay on the SW nodes may include, e.g., die temperature changes, duty cycle changes, process voltage changes or any other changes. These changes may be corrected through the use of the added delays on the cmd signals driving the corresponding SW nodes as described herein.

In some embodiments, the magnitude of added delay applied to cmd signal for SW2 may be a predetermined incremental amount, e.g., a step, that is implemented each switching cycle until the mismatch is removed and SW1 and SW2 are matched in timing. In other embodiments, the magnitude of the t_{mismatch} from the prior switching cycle may be utilized to determine the magnitude of delay to be applied to the SW node transitioning from PGND, e.g., SW2 in this example, via the corresponding cmd signals. For example, not only may the delay itself be variable and adjustable, the magnitude of each step may correspond to or be determined based on the magnitude of the mismatch in some embodiments to enable controller 112 to drive power driver 114 toward a matched ½ VBRIDGE crossing in as few cycles as possible. In some embodiments, when power driver 114 is operating in a stable manner, small adjustments to the delays on one or more cmd signals may be implemented to maintain the ½ VBRIDGE crossings as close to a match as possible.

The added delays may be implemented by a digital delay loop that utilizes feedback monitoring to adjust future signal delays. In some embodiments, the digital delay loop may comprise a feedback loop that operates sequentially over time to add or subtract delays based on feedback from monitoring the mismatch between the ½ VBRIDGE crossings of the SW nodes. The feedback loop may, for example, comprise one or more latch flipflops or other digital or analog components that may be utilized to implement the added delays described above. In an embodiment, a hysteresis algorithm may be utilized that adds a small delay even where no mismatch or a mismatch within a tolerance is detected such that the feedback loop may continuously increase the added delay by a small amount and then decrease the delay by a small amount in order to continuously flip between the SW node transitioning from PGND to VBRIDGE crossing ½ VBRIDGE prior to and after the other SW node.

With reference now to FIGS. 6-8, example signal diagrams are shown according to various embodiments.

FIG. 6 illustrates the first half of a switching cycle, for example, with SW1 transitioning from PGND to VBRIDGE and SW2 transitioning from VBRIDGE to PGND. SW1 crosses VBRIDGE/2 earlier than SW2 as driven by signals cmd_D1, cmd_D2, cmd_D3 and cmd_D4. One or more of signals cmd_D1, cmd_D2, cmd_D3 and cmd_D4 may have variable delays on their falling edges to adjust the timing of the transition of SW1 and SW2 which affects the transition across the VBRIDGE/2 zero crossing point. The timing of the crossing of VBRIDGE/2 by SW1 and SW2 is monitored by signals SW1_gt_VBRIDGE/2 and SW2_st_VBRIDGE/2 which will transition high at the corresponding crossing. The difference between the timing of SW1_gt_VBRIDGE/2 and SW2_st_VBRIDGE/2 corresponds to t_{mismatch}. In some embodiments, a single signal may alternatively be utilized to monitor the ½ VBRIDGE crossings for both the SW1 and SW2 nodes instead of both SW1_gt_VBRIDGE/2 and SW2_st_VBRIDGE/2. For example, the single signal may change from low to high, or vice versa, on each SW node crossing where the timing of the changes of that single signal may be compared to determine t_{mismatch}.

If SW1_gt_VBRIDGE/2 arrives earlier than SW2_st_VBRIDGE/2, up_D2 will be set to high to indicate that the delay on the falling edge of cmd_D2 should be increased for the next cycle. If SW2_st_VBRIDGE/2 arrives earlier than SW1_gt_VBRIDGE/2, down_D2 will be set to high to indicate that the delay on the falling edge of cmd_D2 should be decreased. In the example of FIG. 6, SW1_gt_VBRIDGE/2 arrives earlier than SW2_st_VBRIDGE/2, so up_D2 is set in order to increase the delay on cmd_D2. As seen in FIG. 6, the cmd_D2 waveform already includes a delay, as shown in the circled area, but this delay was insufficient to achieve a matched ½ VBRIDGE zero crossing. The cmd_D2 waveform will have an increased delay next cycle based on the setting of up_D2 to high.

Cmd_D3 is also shown with an optional delay in the example of FIG. 6. This optional delay may be adjustable, predetermined or fixed in some embodiments. For example, in an embodiment, the fixed or adjustable delay on cmd_D3 may be set to a value that ensures that the ½ VBRIDGE crossing of SW2 from VBRIDGE to PGND during the first half of the switching cycle will always occur at a time equal to or later than the ½ VBRIDGE crossing of SW1 from PGND to ½ VBRIDGE in a case where no delay is utilized on cmd_D2.

In an embodiment, if down_D2 causes the delay on cmd_D2 to be set to zero, e.g., the incremental reduction in delay by down_D2 achieves a cmd_D2 signal with no delay at all, the down_D2 signal may instead be replaced with an up_D3 signal (not shown) that increases the delay on cmd_D3. As an example, this may occur in a case where one or more operating parameters of power driver 114 have changed to the extent that the optional delay on cmd_D3 is no longer sufficient to ensure that the ½ VBRIDGE crossing of SW2 from VBRIDGE to PGND during the first half of the switching cycle will always occur at a time equal to or later than the ½ VBRIDGE crossing of SW1 from PGND to ½ VBRIDGE in a case where no delay is utilized on cmd_D2. In this manner, the delay on cmd_D3 may be adjusted to maintain the relationship between the zero crossings of SW1 and SW2 in the case where no delay is utilized on cmd_D2.

FIG. 7 illustrates the second half of a switching cycle, for example, with SW2 transitioning from PGND to VBRIDGE and SW1 transitioning from VBRIDGE to PGND. SW2 crosses VBRIDGE/2 earlier than SW1 as driven by signals cmd_D1, cmd_D2, cmd_D3 and cmd_D4. The timing of the crossing of VBRIDGE/2 by SW1 and SW2 is again monitored by signals SW1_gt_VBRIDGE/2 and SW2_st_VBRIDGE/2 which will transition low at the corresponding crossing (in the opposite direction to FIG. 6 since the SW node transitions are occurring in the opposite direction in FIG. 7). The difference between the timing of SW2_gt_VBRIDGE/2 and SW1_st_VBRIDGE/2 corresponds to t_{mismatch}.

If SW2_gt_VBRIDGE/2 arrives earlier than SW1_st_VBRIDGE/2, up_D4 will be set to high to indicate that the delay on the falling edge of cmd_D4 should be increased for the next cycle. If SW1_st_VBRIDGE/2 arrives earlier than SW2_gt_VBRIDGE/2, down_D4 will be set to high to indicate that the delay on the falling edge of cmd_D4 should be decreased. In the example of FIG. 7, SW2_gt_VBRIDGE/2 arrives earlier than SW1_st_VBRIDGE/2, so up_D4 is set in order to increase the delay on cmd_D4. As seen in FIG. 7, the cmd_D4 waveform already includes a delay, as shown in the circled area, but this delay was insufficient to achieve a matched ½ VBRIDGE zero crossing. The cmd_D4 waveform will have an increased delay next cycle based on the setting of up_D4 to high. Cmd_D1 is also shown with an optional delay in the example of FIG. 7. This optional delay may be adjustable, predetermined or fixed in some embodiments. For example, the fixed delay on cmd_D1 may be set to a value that ensures that the ½ VBRIDGE crossing of SW1 from VBRIDGE to PGND during the second half of the switching cycle will always occur at a time equal to or later than the ½ VBRIDGE crossing of SW2 from PGND to ½ VBRIDGE in a case where no delay is utilized on cmd_D4.

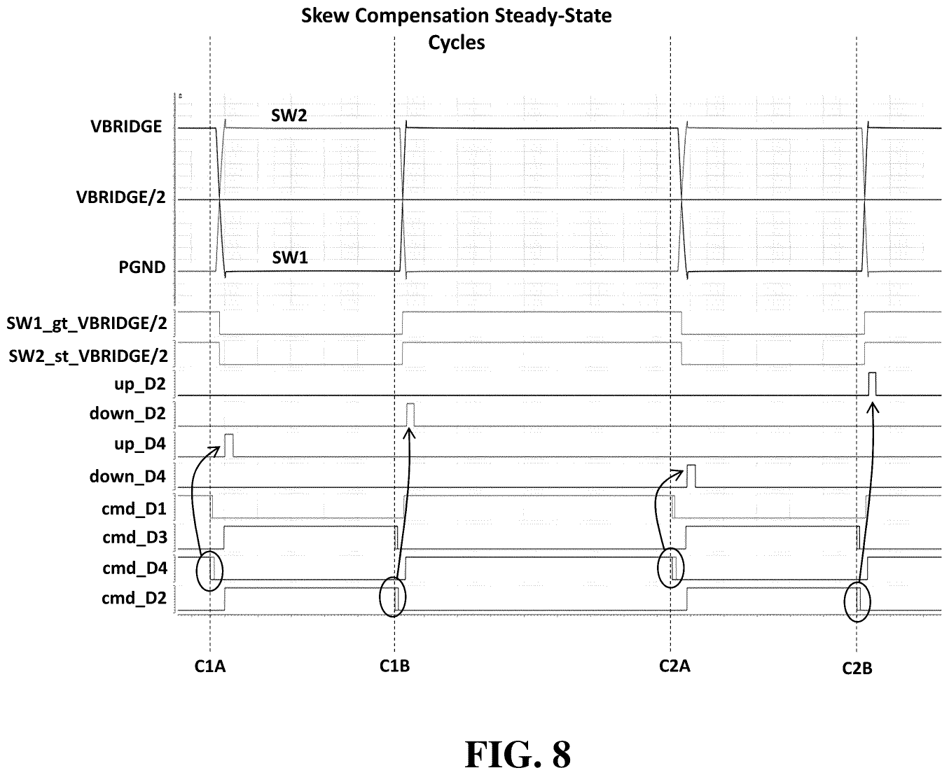

FIG. 8 illustrates a signal diagram showing the use of adjustable delays on the cmd signals of the SW nodes through multiple switching cycles. In this signal diagram, transmitter 110 has been operating for multiple switching cycles with the mismatch between the ½ VBRIDGE crossings of the SW nodes being driven to as small a difference as possible with SW1_gt_VBRIDGE/2 and SW2_st_VBRIDGE/2 almost aligned and the up and down signals being determined based on very small differences to cause a dithering effect.

Initially SW2 is set to VBRIDGE and SW1 is set to PGND. During a first half C1A of the first cycle, SW2 transitions from VBRIDGE to PGND while SW1 transitions from PGND to VBRIDGE. Cmd_D4 has an initial delay, e.g., based on a prior setting of up_D4 or down_D4. SW1 crosses VBRIDGE/2 prior to SW2 by a small mismatch, causing up_D4 to be set to increase the amount of delay on cmd_D4 for the next switching cycle.

During a second half C1B of the first cycle, SW1 transitions from VBRIDGE to PGND while SW2 transitions from PGND to VBRIDGE. Cmd_D2 has an initial delay, e.g., based on a prior setting of up_D2 or down_D2. SW1 again crosses VBRIDGE/2 prior to SW2 by a small mismatch, causing down_D2 to be set to decrease the amount of delay on cmd_D2 for the next switching cycle.

During a first half C2A of the second cycle, SW2 transitions from VBRIDGE to PGND while SW1 transitions from PGND to VBRIDGE. Cmd_D4 has an initial delay based on the prior setting of up_D4 in CIA. SW1 now crosses VBRIDGE/2 later than SW2 by a small mismatch, causing down_D4 to be set to decrease the amount of delay on cmd_D4 for the next switching cycle.

During a second half C2B of the second cycle, SW1 transitions from VBRIDGE to PGND while SW2 transitions from PGND to VBRIDGE. Cmd_D2 has an initial delay based on the prior setting of down_D2 in C1B. SW1 again crosses VBRIDGE/2 later than SW2 by a small mismatch, causing up_D2 to be set to increase the amount of delay on cmd_D2 for the next switching cycle.

In this manner, the mismatch is dithered between increasing the delay, e.g., using the corresponding up_D4 and up_D2 signals, and decreasing the delay, e.g., using the corresponding down_D4 and down_D2 signals, for each half cycle to drive skew compensations in steady-state cycles. In a case where the same SW node crosses VBRIDGE/2 first over multiple cycles, the corresponding up or down signal may be set each cycle to increase or decrease the delay on the corresponding cmd signal until that SW node crosses VBRIDGE/2 at the same time or later than the other SW node, at which point the dithering process shown in FIG. 8 may be employed to maintain the SW node crossings in as close to a match as possible.

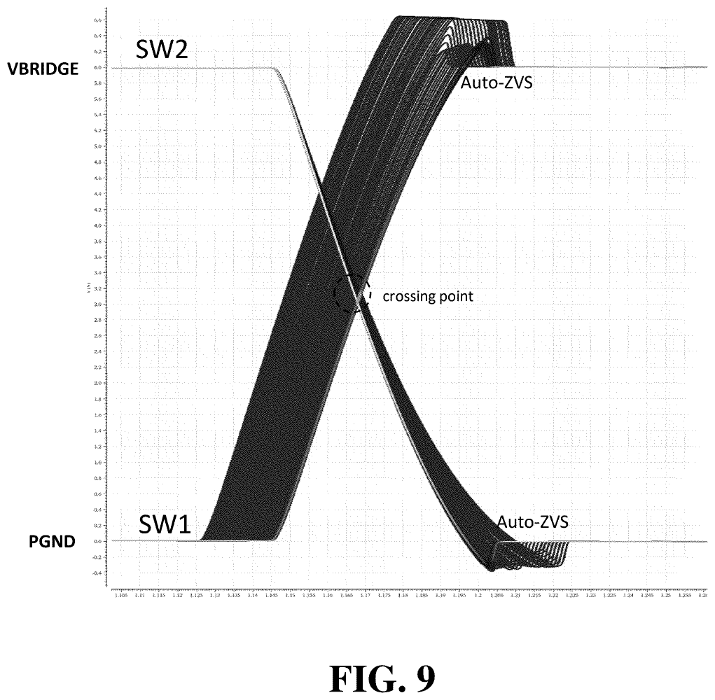

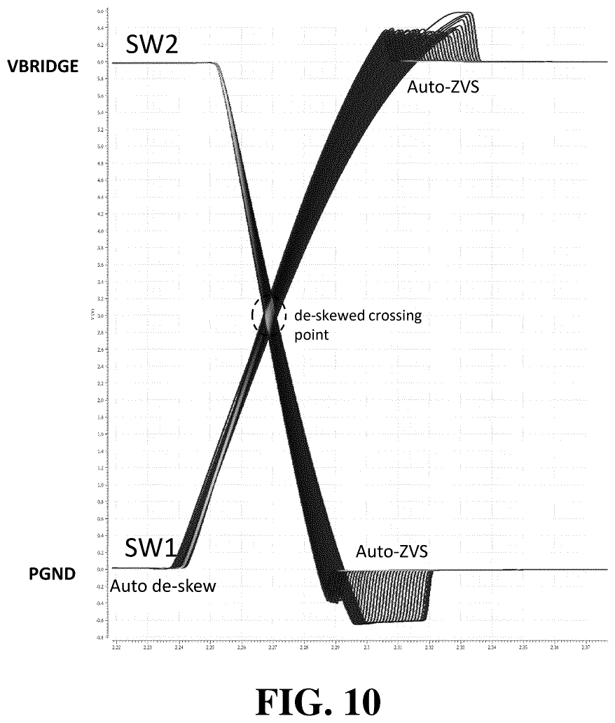

FIGS. 9 and 10 illustrate eye diagrams showing the effect of adjustable delays on the cmd signals of the SW nodes over time to drive the mismatch to as small a value as possible.

In FIG. 9, initially SW2 is set to VBRIDGE and SW1 is set to PGND. Each cycle, delay is added to the turn-off point of SW1 until the ½ VBRIDGE crossing points are aligned. This is illustrated by the SW 1 lines progressively moving toward the right as additional delays are added until the ½ VBRIDGE crossing points of SW2 and SW1 are aligned, e.g., within the dashed line circle. In some embodiments, an automatic turn-on adjustment may also be added to adjust the turn-on points of the SW1 and SW2 nodes cycle by cycle.

In FIG. 10, initially SW2 is set to VBRIDGE and SW1 is set to PGND. Automatic de-skewing is implemented once the ½ VBRIDGE crossing points are aligned in the dashed-circle implemented by dithering the delays on the SW node transitioning from PGND to VBRIDGE in the manner described above with reference to FIG. 8.

While skew compensation is shown as affecting the falling edges of one or more of the cmd signals with no changes to the timing of the rising edges in the provided examples. In other embodiments, the skew compensation may alternatively affect the rising edges with no changes to the falling edges of one or more of the cmd signals. In yet other embodiments, the skew compensation may affect both the rising and falling edges of one or more of the cmd signals.

### EXAMPLES

Example 1: A wireless power transmitter comprising: a coil; a first node electrically connected to a first side of the coil; a second node electrically connected to a second side of the coil; a first transistor in electrical communication with a first voltage potential and the first node, the first transistor being configured to electrically connect the first voltage potential to the first node based on a first command signal; a second transistor in electrical communication with a second voltage potential and the second node, the second transistor being configured to electrically connect the second voltage potential to the second node based on a second command signal, the first transistor and the second transistor being configured to transition the first node from the first voltage potential toward the second voltage potential and the second node from the second voltage potential toward the first voltage potential based on the first and second command signals; a monitor circuit configured to: determine a first time at which a first voltage of the first node crosses a halfway point between the first voltage potential and the second voltage potential; and determine a second time at which a second voltage of the second node crosses the halfway point between the second voltage potential and the first voltage potential; and a feedback circuit that is configured to adjust a delay of the second command signal based at least in part on one of the first and second times occurring before the other of the first and second times.
Example 2: The wireless power transmitter of Example 1, wherein the delay of the second command signal comprises a delay of a falling edge of the second command signal.
Example 3: The wireless power transmitter of any one of Examples 1 and 2, wherein the first and second command signals comprise pulse width modulation signals.
Example 4: The wireless power transmitter of any one of Examples 1 to 3, wherein the second voltage potential corresponds to ground.
Example 5: The wireless power transmitter of any one of Examples 1 to 4, wherein: the monitor circuit is configured to determine the first and second times during a current switching cycle of the power transmitter; and the feedback circuit is configured to adjust the delay of the second command signal for a future switching cycle of the power transmitter.
Example 6: The wireless power transmitter of any one of Examples 1 to 5, wherein the feedback circuit is configured to: increase the delay of the second command signal for the future switching cycle based at least in part on the first time occurring before the second time during the current switching cycle; and decrease the delay of the second command signal for the future switching cycle based at least in part on the first time occurring after the second time during the current switching cycle.
Example 7: The wireless power transmitter of any one of Examples 1 to 6, wherein one of the first node and the second node is electrically connected to the coil via a capacitor.
Example 8: The wireless power transmitter of any one of Examples 1 to 7, wherein a magnitude of the adjustment to the delay of the second command signal is fixed at a pre-determined value.
Example 9: The wireless power transmitter of any one of Examples 1 to 8, wherein a magnitude of the adjustment to the delay of the second command signal is determined based on a magnitude of a time difference between the first time and the second time.
Example 10: The wireless power transmitter of any one of Examples 1 to 9, wherein the first command signal comprises a delay that is configured cause the first time to be later than the second time when the delay of the second command signal is zero.
Example 11: A wireless power transmitter comprising: a coil; a first node electrically connected to a first side of the coil; a second node electrically connected to a second side of the coil; a first transistor in electrical communication with a first voltage potential and the first node, the first transistor being configured to electrically connect the first voltage potential to the first node based on a first command signal; a second transistor in electrical communication with a second voltage potential and the second node, the second transistor being configured to electrically connect the second voltage potential to the second node based on a second command signal, the first transistor and the second transistor being configured to transition the first node from the first voltage potential toward the second voltage potential and the second node from the second voltage potential toward the first voltage potential based on the first and second command signals during a first half of a switching cycle; a third transistor in electrical communication with the first voltage potential and the second node, the third transistor being configured to electrically connect the first voltage potential to the second node based on a third command signal; a fourth transistor in electrical communication with the second voltage potential and the first node, the fourth transistor being configured to electrically connect the second voltage potential to the first node based on a fourth command signal, the third transistor and the fourth transistor being configured to transition the first node from the second voltage potential toward the first voltage potential and the second node from the first voltage potential toward the second voltage potential based on the third and fourth command signals during a second half of the switching cycle; a monitor circuit that is configured to: determine a first time at which a first voltage of the first node crosses a halfway point between the first voltage potential and the second voltage potential; and determine a second time at which a second voltage of the second node crosses the halfway point between the first voltage potential and the second voltage potential; and a feedback circuit that is configured to: adjust a delay of the second command signal based at least in part on one of the first and second times occurring before the other of the first and second times during the first half of the switching cycle; and adjust a delay of the fourth command signal based at least in part on one of the first and second times occurring before the other of the first and second times during the second half of the switching cycle.
Example 12: The wireless power transmitter of Example 11, wherein: the delay of the second command signal comprises a delay of a falling edge of the second command signal during the first half of the switching cycle; and the delay of the fourth command signal comprises a delay of a falling edge of the fourth command signal during the second half of the switching cycle.
Example 13: The wireless power transmitter of any one of Examples 11 and 12, wherein the first, second, third and fourth command signals comprise pulse width modulation signals.
Example 14: The wireless power transmitter of any one of Examples 11 to 13, wherein the second voltage potential corresponds to ground.
Example 15: The wireless power transmitter of any one of Examples 11 to 14, wherein: the monitor circuit is configured to determine the first and second times during each of the first and second halves of a current switching cycle of the power transmitter; and the feedback circuit is configured to: adjust the delay of the second command signal for the first half of a future switching cycle of the power transmitter based at least in part on the first and second times determined during the first half of the current switching cycle; and adjust the delay of the fourth command signal for the second half of the future switching cycle of the power transmitter based at least in part on the first and second times determined during the second half of the current switching cycle.
Example 16: The wireless power transmitter of any one of Examples 11 to 15, wherein the feedback circuit is configured to: increase the delay of the second command signal for the first half of the future switching cycle based at least in part on the first time occurring before the second time during the first half of the current switching cycle; decrease the delay of the second command signal for the first half of the future switching cycle based at least in part on the first time occurring after the second time during the first half of the current switching cycle; increase the delay of the fourth command signal for the second half of the future switching cycle based at least in part on the first time occurring before the second time during the second half of the current switching cycle; and decrease the delay of the fourth command signal for the second half of the future switching cycle based at least in part on the first time occurring after the second time during the second half of the current switching cycle.
Example 17: The wireless power transmitter of any one of Examples 11 to 16, wherein a magnitude of the adjustments to the delays of the second command signal and the fourth command signal are fixed at a pre-determined value.
Example 18. The wireless power transmitter of any one of Examples 11 to 17, wherein a magnitude of the adjustment to the delays of the second and fourth command signals is determined based on a magnitude of a time difference between the first time and the second time for each of the corresponding first and second halves of the switching cycle.
Example 19: A wireless power transmitter comprising: a coil; a first node electrically connected to a first side of the coil; a second node electrically connected to a second side of the coil; a plurality of transistors that are configured to drive the coil via the first and second nodes between a first voltage potential and a second voltage potential; a monitor circuit configured to: determine a first time at which a first voltage of the first node crosses a halfway point between the first voltage potential and the second voltage potential; and determine a second time at which a second voltage of the second node crosses a halfway point between the first voltage potential and the second voltage potential; and a feedback circuit that is configured to adjust a delay corresponding to at least one transistor of the plurality of transistors based at least in part on one of the first and second times occurring before the other of the first and second times.
Example 20: The wireless power transmitter of Example 19, wherein: the monitor circuit is configured to determine the first and second times during a current switching cycle of the power transmitter; and the feedback circuit is configured to: increase the delay corresponding to the at least one transistor of the plurality of transistors for a future switching cycle based at least in part on the first time occurring before the second time during the current switching cycle; and decrease the delay corresponding to the at least one transistor of the plurality of transistors for the future switching cycle based at least in part on the first time occurring after the second time during the current switching cycle.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. M any modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A wireless power transmitter comprising:
a coil;
a first node electrically connected to a first side of the coil;
a second node electrically connected to a second side of the coil;
a first transistor in electrical communication with a first voltage potential and the first node, the first transistor being configured to electrically connect the first voltage potential to the first node based on a first command signal;
a second transistor in electrical communication with a second voltage potential and the second node, the second transistor being configured to electrically connect the second voltage potential to the second node based on a second command signal, the first transistor and the second transistor being configured to transition the first node from the first voltage potential toward the second voltage potential and the second node from the second voltage potential toward the first voltage potential based on the first and second command signals;
a monitor circuit configured to:
determine a first time at which a first voltage of the first node crosses a halfway point between the first voltage potential and the second voltage potential; and
determine a second time at which a second voltage of the second node crosses the halfway point between the second voltage potential and the first voltage potential; and
a feedback circuit configured to adjust a delay of the second command signal based at least in part on one of the first and second times occurring before the other of the first and second times.

2. The wireless power transmitter of claim 1, wherein the delay of the second command signal comprises a delay of a falling edge of the second command signal.

3. The wireless power transmitter of claim 1, wherein the first and second command signals comprise pulse width modulation signals.

4. The wireless power transmitter of claim 1, wherein the second voltage potential corresponds to ground.

5. The wireless power transmitter of claim 1, wherein:
the monitor circuit is configured to determine the first and second times during a current switching cycle of the power transmitter; and
the feedback circuit is configured to adjust the delay of the second command signal for a future switching cycle of the power transmitter.

6. The wireless power transmitter of claim 5, wherein the feedback circuit is configured to:
increase the delay of the second command signal for the future switching cycle based at least in part on the first time occurring before the second time during the current switching cycle; and
decrease the delay of the second command signal for the future switching cycle based at least in part on the first time occurring after the second time during the current switching cycle.

7. The wireless power transmitter of claim 1, wherein one of the first node and the second node is electrically connected to the coil via a capacitor.

8. The wireless power transmitter of claim 1, wherein a magnitude of the adjustment to the delay of the second command signal is fixed at a pre-determined value.

9. The wireless power transmitter of claim 1, wherein a magnitude of the adjustment to the delay of the second command signal is determined based on a magnitude of a time difference between the first time and the second time.

10. The wireless power transmitter of claim 1, wherein the first command signal comprises a delay that is configured cause the first time to be later than the second time when the delay of the second command signal is zero.

11. A wireless power transmitter comprising:
a coil;
a first node electrically connected to a first side of the coil;
a second node electrically connected to a second side of the coil;
a first transistor in electrical communication with a first voltage potential and the first node, the first transistor being configured to electrically connect the first voltage potential to the first node based on a first command signal;
a second transistor in electrical communication with a second voltage potential and the second node, the second transistor being configured to electrically connect the second voltage potential to the second node based on a second command signal, the first transistor and the second transistor being configured to transition the first node from the first voltage potential toward the second voltage potential and the second node from the second voltage potential toward the first voltage potential based on the first and second command signals during a first half of a switching cycle;
a third transistor in electrical communication with the first voltage potential and the second node, the third transistor being configured to electrically connect the first voltage potential to the second node based on a third command signal;
a fourth transistor in electrical communication with the second voltage potential and the first node, the fourth transistor being configured to electrically connect the second voltage potential to the first node based on a fourth command signal, the third transistor and the fourth transistor being configured to transition the first node from the second voltage potential toward the first voltage potential and the second node from the first voltage potential toward the second voltage potential based on the third and fourth command signals during a second half of the switching cycle; and
a monitor circuit configured to:
determine a first time at which a first voltage of the first node crosses a halfway point between the first voltage potential and the second voltage potential; and
determine a second time at which a second voltage of the second node crosses the halfway point between the first voltage potential and the second voltage potential; and
a feedback circuit that is configured to:
adjust a delay of the second command signal based at least in part on one of the first and second times occurring before the other of the first and second times during the first half of the switching cycle; and
adjust a delay of the fourth command signal based at least in part on one of the first and second times occurring before the other of the first and second times during the second half of the switching cycle.

12. The wireless power transmitter of claim 11, wherein:
the delay of the second command signal comprises a delay of a falling edge of the second command signal during the first half of the switching cycle; and
the delay of the fourth command signal comprises a delay of a falling edge of the fourth command signal during the second half of the switching cycle.

13. The wireless power transmitter of claim 11 wherein the first, second, third and fourth command signals comprise pulse width modulation signals.

14. The wireless power transmitter of claim 11, wherein the second voltage potential corresponds to ground.

15. The wireless power transmitter of claim 11, wherein:
the monitor circuit is configured to determine the first and second times during each of the first and second halves of a current switching cycle of the power transmitter; and
the feedback circuit is configured to:
adjust the delay of the second command signal for the first half of a future switching cycle of the power transmitter based at least in part on the first and second times determined during the first half of the current switching cycle; and
adjust the delay of the fourth command signal for the second half of the future switching cycle of the power transmitter based at least in part on the first and second times determined during the second half of the current switching cycle.

16. The wireless power transmitter of claim 15, wherein the feedback circuit is configured to:
increase the delay of the second command signal for the first half of the future switching cycle based at least in part on the first time occurring before the second time during the first half of the current switching cycle;
decrease the delay of the second command signal for the first half of the future switching cycle based at least in part on the first time occurring after the second time during the first half of the current switching cycle;
increase the delay of the fourth command signal for the second half of the future switching cycle based at least in part on the first time occurring before the second time during the second half of the current switching cycle; and
decrease the delay of the fourth command signal for the second half of the future switching cycle based at least in part on the first time occurring after the second time during the second half of the current switching cycle.

17. The wireless power transmitter of claim 11, wherein a magnitude of the adjustments to the delays of the second command signal and the fourth command signal are fixed at a pre-determined value.

18. The wireless power transmitter of claim 11, wherein a magnitude of the adjustment to the delays of the second and fourth command signals is determined based on a magnitude of a time difference between the first time and the second time for each of the corresponding first and second halves of the switching cycle.

19. A wireless power transmitter comprising:
a coil;
a first node electrically connected to a first side of the coil;
a second node electrically connected to a second side of the coil;
a plurality of transistors that are configured to drive the coil via the first and second nodes between a first voltage potential and a second voltage potential;
a monitor circuit configured to:
determine a first time at which a first voltage of the first node crosses a halfway point between the first voltage potential and the second voltage potential; and
determine a second time at which a second voltage of the second node crosses a halfway point between the first voltage potential and the second voltage potential; and
a feedback circuit that is configured to adjust a delay corresponding to at least one transistor of the plurality of transistors based at least in part on one of the first and second times occurring before the other of the first and second times.

20. The wireless power transmitter of claim 19, wherein:
the monitor circuit is configured to determine the first and second times during a current switching cycle of the power transmitter; and
the feedback circuit is configured to:
increase the delay corresponding to the at least one transistor of the plurality of transistors for a future switching cycle based at least in part on the first time occurring before the second time during the current switching cycle; and
decrease the delay corresponding to the at least one transistor of the plurality of transistors for the future switching cycle based at least in part on the first time occurring after the second time during the current switching cycle.
